(19) United States
(12) Patent Application Publication
(10) Pub. No.: US 2013/0275867 A1
(43) Pub. Date: Oct. 17, 2013

(54) DOCUMENT VIEWING APPARATUS AND TANGIBLE COMPUTER-READABLE RECORDING MEDIUM

(71) Applicant: KONICA MINOLTA, INC., Chiyoda-ku (JP)

(72) Inventors: Masayuki INOUE, Hachioji-shi (JP); Keiichiro HYODO, Kokubunji-shi (JP); Tetsuhiro SHIBATA, Hamamatsu-shi (JP)

(73) Assignee: Konica Minolta, Inc., Chiyoda-ku (JP)

(21) Appl. No.: 13/863,777

(22) Filed: Apr. 16, 2013

(30) Foreign Application Priority Data
Apr. 17, 2012 (JP) 2012-094005

(51) Int. Cl. G06F 17/27

(52) U.S. Cl. CPC G06F 17/27
USPC 715/277

(57) ABSTRACT

Disclosed is a document viewing apparatus including: a display unit to display a page designation object for receiving designation of a document or designation of any page in one document; an operating unit to receive a page designating operation for the page designation object; and a control unit; wherein in case that there are a plurality of documents to be displayed, the control unit instructs the display unit to display the page designation objects corresponding to the plurality of documents to be displayed, respectively, and when the operating unit receives the page designating operation for any one of the page designation objects which are currently displayed, the control unit instructs the display unit to display a page designated by the page designating operation, the displayed page being contained in a document corresponding to the page designation object for which the page designating operation is received.

### BACKGROUND OF THE INVENTION

1. Field of the Invention

The present invention relates to a document viewing apparatus for displaying a document and a tangible computer-readable recording medium which stores a program therefor.

2. Description of Related Art

When one specific page in a document including many pages is displayed on a display apparatus, the page number of the displayed page in the entire document is generally displayed in the form of a fraction, for example, “page position/total number of pages”. There is also a technology of more intuitively displaying the page number of the displayed page.

In an example of conventional technologies, in addition to a “forward” button and a “back” button for turning pages, a bar is displayed in each of these buttons so as to relate the width of the bar to the ratio of one page to the total number of pages of the document when the width of the button is related to the total number of pages, and so as to relate the position of the bar to the position of the current displayed page (for example, See Japanese Patent Application Publication No. 2001-051769).

In another example, a data display apparatus displays a plurality of bars assigned to all of the pages respectively, so as to discriminate a bar corresponding to the current displayed page from the other bars by using different colors or the like. Thereby, it is possible to easily grasp the page number of the current displayed page in the entire data (for example, See Japanese Patent Application Publication No. 2004-021467).

The technologies disclosed in Japanese Patent Application Publication Nos. 2001-051769 and 2004-021467 described above are used for one document. On the other hand, in recent years, information processing apparatuses capable of opening a plurality of documents have become widely available. In the situation in which a plurality of documents are open (a plurality of documents are set to the documents be displayed), in order to designate and display a specific page of a specific document among these documents, a two-step operation in which the specific document is first selected, and the position of the page in the selected document is then designated, is required. This operation is cumbersome.

Moreover, there has been no user I/F that can intuitively grasp the total number of pages of a plurality of documents to be displayed, a ratio of the number of pages of each document with respect to the whole of the plurality of documents, a page position in the whole of the plurality of documents, and the like, even the plurality of documents to be displayed are related to each other.

### SUMMARY

To achieve at least one of the abovementioned objects, a document viewing apparatus reflecting one aspect of the present invention, comprises:

a display unit to display a page designation object for receiving designation of a document or designation of any page in one document;

an operating unit to receive a page designating operation for the page designation object; and

a control unit;

wherein in case that there are a plurality of documents to be displayed, the control unit instructs the display unit to display the page designation objects corresponding to the plurality of documents to be displayed, respectively, and when the operating unit receives the page designating operation for any one of the page designation objects which are currently displayed, the control unit instructs the display unit to display a page designated by the page designating operation, the designated page being contained in a document corresponding to the page designation object for which the page designating operation is received.

Preferably, the entire page designation object corresponds to one document, and a page position in the one document is specified by a position indicated in the page designation object, and

the page designating operation is an operation of selecting any portion in the page designation object.

Preferably, the control unit indicates the display unit to display a predetermined identification mark in the page designation object corresponding to the document containing the page which is currently displayed, the predetermined identification mark being displayed at a position corresponding to the page which is currently displayed.

Preferably, the control unit instructs the display unit to display the page designation objects corresponding to the plurality of documents to be displayed, respectively, as one coupled page designation object formed by coupling the page designation objects so as to enable each boundary between the page designation objects to be recognized.

Preferably, the coupled page designation object has a constant size, and each size of the page designation objects corresponding to the plurality of documents is set according to a ratio of the number of pages of each document to the numbers of pages of the plurality of documents to be displayed.

Preferably, the control unit instructs the display unit to display the coupled page designation object formed by arranging the page designation objects in an order of setting the document corresponding to the page designation object, to the document to be displayed.

Preferably, the page designation object has a stick form, a full length of the page designation object corresponds to one entire document, and a page position in the one entire document is specified by a position indicated in the page designation object.

Preferably, the control unit instructs the display unit to display first page information for the document containing the page which is currently displayed on the display unit, among the plurality of documents to be displayed, and

the control unit instructs the display unit to display second page information for the other document among the plurality of documents to be displayed,

wherein the first page information indicates a page number of the page which is currently displayed on the display unit and the number of pages of the document containing the page which is currently displayed, so as to relate the page number and the number of pages of the document containing the page which is currently displayed, to the page designation object corresponding to the document containing the page which is currently displayed, and

wherein the second page information indicates the number of pages of the other document so as to relate the number of pages of the other document to the page designation object corresponding to the other document.

Preferably, when the operating unit receives the page designating operation for any one of the page designation objects which are currently displayed after the operating unit receives an operation for designating a process for processing the page designated by the page designating operation, the control unit performs the designated process for the page which is designated by the page designating operation and which is contained in the document corresponding to the page designation object for which the page designating operation is received.

Preferably, when the operating unit receives an operation for designating a process, an operation for designating a target to be processed page by page and the page designating operation for any one of the page designation objects which are currently displayed, the control unit performs the designated process for the page which is designated by the page designating operation and which is contained in the document corresponding to the page designation object for which the page designating operation is received; and

when the operating unit receives the operation for designating the process, an operation for designating a target to be processed document by document and the page designating operation for any one of the page designation objects which are currently displayed, the control unit performs the designated process for the entire document corresponding to the page designation object for which the page designating operation is received.

Preferably, the document viewing apparatus further comprises an input unit to input data of the document from an external apparatus,

wherein when the input unit inputs the data of the document, the control unit sets the document including the data input by the input unit, to the document to be displayed.

Preferably, when the operating unit receives a request for preparing a new page, the control unit sets the new page to the document to be displayed and instructs the display unit to display the page designation object corresponding to the new page.

Preferably, when the number of the documents to be displayed exceeds a predetermined number, the control unit instructs the display unit to display neither the first page information nor the second page information, or not to display the second page information.

Preferably, among the plurality of documents to be displayed, the plurality of documents in which a predetermined common requirement is satisfied are grouped and are displayed as one page designation object.

Preferably, the predetermined common requirement includes at least one of a date on which the document is registered as the document to be displayed, a transmission source which transmits the document, and a transmission destination to which the document is transmitted.

Preferably, in the coupled page designation object, colors of the page designation objects are varied so as to enable each boundary the page designation objects to be recognized.

Preferably, the display unit is a memory-type display device in which display contents displayed on the display unit are maintained after the document viewing apparatus is powered off

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is an explanatory view showing a general outline of a document viewing apparatus and the utility form thereof according to the embodiment;

FIG. 2 is a block diagram of a schematic structure of an electric system of the document viewing apparatus according to the embodiment;

FIG. 3 is a view showing the structure of a standard window to be displayed on a display unit of the document viewing apparatus according to the embodiment;

FIGS. 4A to 4G are explanatory views showing the transition of a seek bar and the like in case that documents to be displayed are sequentially added from an initial state in which no document to be displayed is present;

FIG. 5 is a flowchart of a process of adding a document to be displayed;

FIG. 6 is a flowchart of a process of changing a current displayed page by receiving a touch operation on the seek bar;

FIGS. 7A to 7D are explanatory views showing a user procedure in case that all documents registered as the documents to be displayed are deleted and the transition of a display state in a search information display area;

FIGS. 8A to 8E are explanatory views showing a user procedure in case that any of documents or pages to be displayed is deleted and the transition of a display state in the search information display area;

FIG. 9 is a flowchart of a deleting process to be performed by the document viewing apparatus;

FIGS. 10A to 10F are explanatory views showing a user procedure in case that a document or a page registered as the document or the page to be displayed is moved and the transition of a display state in the search information display area;

FIG. 11 is a flowchart of a moving process to be performed by the document viewing apparatus;

FIGS. 12A to 12C are explanatory views showing a user procedure in case that all documents registered as the documents to be displayed are transmitted to an external apparatus and the transition of a display state in the search information display area;

FIGS. 13A to 13C are explanatory views showing a user procedure in case that any of documents or pages to be displayed is transmitted to an external apparatus and the transition of a display state in the search information display area;

FIG. 14 is a flowchart of a transmitting process to be performed by the document viewing apparatus;

FIG. 15 is a view showing a vertical seek bar;

FIGS. 16A and 16B are views showing a step-like seek bar having sections arranged in a stepwise manner;

FIGS. 17A and 17B are views showing an example in case that independent document bars are displayed for the respective documents;

FIGS. 18A and 18B are views showing an example in case that independent document bars are displayed for the respective documents and each document bar has a length according to the number of pages of each document;

FIGS. 19A to 19C are views showing the seek bar in case that the detailed document information and the number-of-pages information for each document are omitted when many documents to be displayed are present; and

FIGS. 20A and 20B are views showing examples of a seek bar in which different colors are used for the respective sections.

### DETAILED DESCRIPTION OF PREFERRED EMBODIMENTS

Hereinafter, a preferred embodiment of the present invention will be explained with reference to the accompanying drawings.

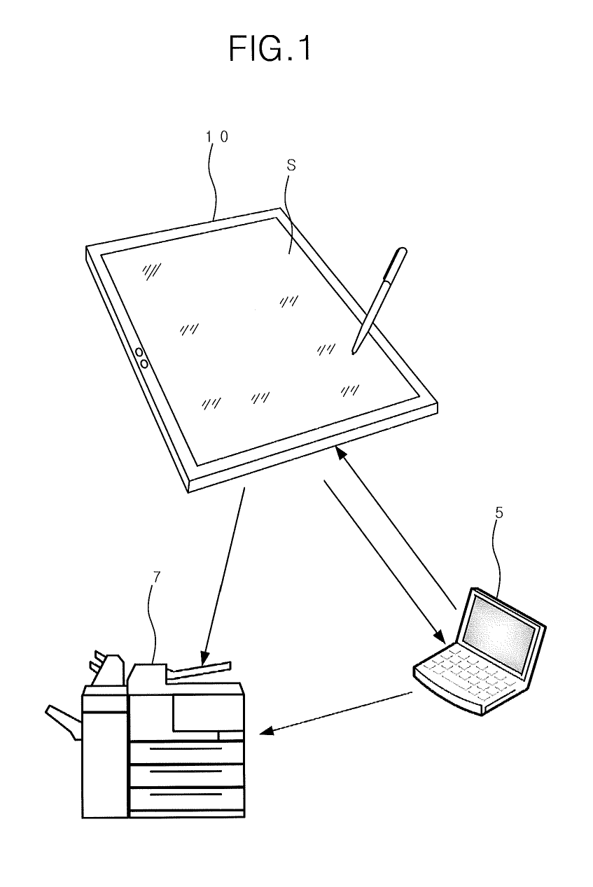

FIG. 1 shows a general outline of a document viewing apparatus 10 and the utility form thereof according to the embodiment.

The document viewing apparatus 10 can wirelessly communicate with an external apparatus, for example, an information processing apparatus 5 such as a personal computer, or a printing apparatus 7. The document viewing apparatus 10 has the function of receiving a scanned image obtained by reading an original with a reading unit of the printing apparatus 7 or data of the document from the information processing apparatus 5 or the like, the function of displaying and editing the scanned image or the data of the document (which are referred to as a document), and the function of adding a hand-written memo to the scanned image or the data of the document. Also, the document viewing apparatus 10 has the function of transmitting a document obtained by carrying out the process of adding a hand-written memo or the like, to the external apparatus such as the information processing apparatus 5 or the printing apparatus 7. The document viewing apparatus 10 is used for, by way of example, the proofreading and the correction of a document before printing.

The document viewing apparatus 10 is an approximately A4-sized portable terminal shaped in a flat plate, and has a display surface S of a memory display device on the entire front surface. The memory-type display device is a display apparatus that maintains display contents even if the device is powered off and continues to display the contents. For example, the document viewing apparatus 10 is configured of an electronic paper of a particle migration type.

On the display surface S of the memory-type display device, a touch panel for detecting a position on which the display surface S is touched with a finger or pen, is provided.

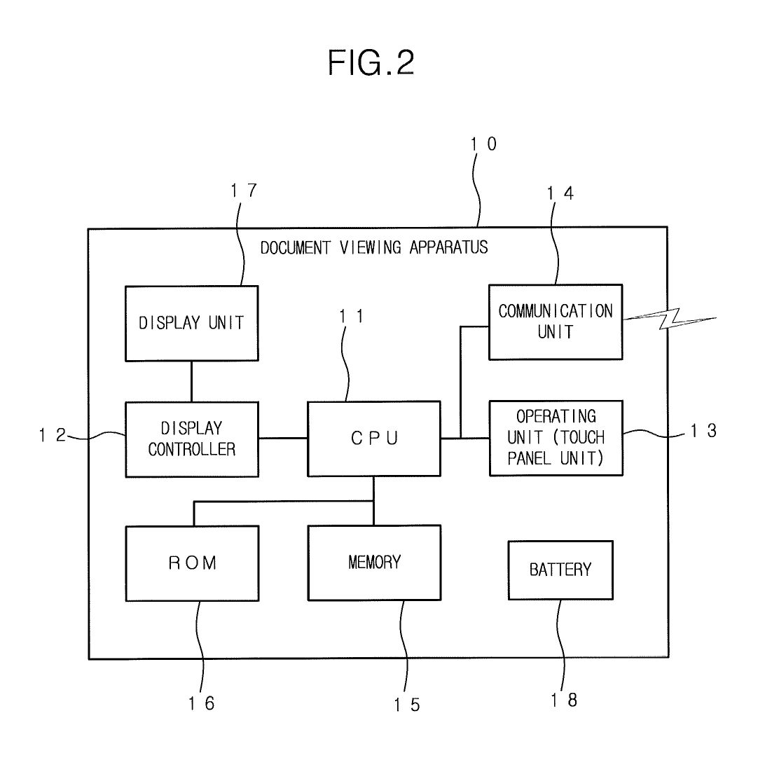

FIG. 2 shows a schematic structure of an electric system of the document viewing apparatus 10. The document viewing apparatus 10 is configured so as to connect a display controller 12 which is connected with a display unit 17, an operating unit 13, a communication unit 14, a memory 15, and a ROM (Read Only Memory) 16, to a CPU 11 as a control unit for centralizedly controlling the operation of the document viewing apparatus 10. The document viewing apparatus 10 also comprises a battery 18 that supplies power to each unit of the document viewing apparatus 10.

The display unit 17 is configured by the memory-type display device described above. The display controller 12 transmits various control signals and display data to the display unit 17 and controls the rewriting of display contents. A window to be actually displayed is generated by the CPU 11. The operating unit 13 is provided on the display surface S of the display unit 17, and is configured to comprise a touch panel that detects a position on which the display surface S is depressed with a finger or pen, operation switches arranged at a surrounding edge of the display surface S of the document viewing apparatus 10.

The document viewing apparatus 10 can receive the inputs of a hand-written object such as a character and a graphic written by user's hand through the touch panel. Any touch panel detection scheme can be used, such as capacitance, analog/digital resistant film, infrared ray, ultrasound, or electromagnetic induction.

The communication unit 14 is connected to a network via wireless communication, and has a function of communicating with an external apparatus such as the information processing apparatus 5 and the printing apparatus 7.

In the ROM 16, various programs and data are stored. By executing the various processes by the CPU 11 in accordance with these programs, each function of the document viewing apparatus 10 can be realized. The memory 15 is used as a work memory for temporarily storing various data when the CPU 11 executes a program and a memory for temporarily storing display data.

The document viewing apparatus 10 registers a document received from the external apparatus such as the information processing apparatus 5 as a document to be displayed. When another document is received in the situation in which any document is registered as the document to be displayed, the received document is additionally registered also as the document to be displayed. The document viewing apparatus 10 displays any one page selected from one or a plurality of documents registered as the documents to be displayed as described above, and accepts the hand-writing or the correction for the displayed page.

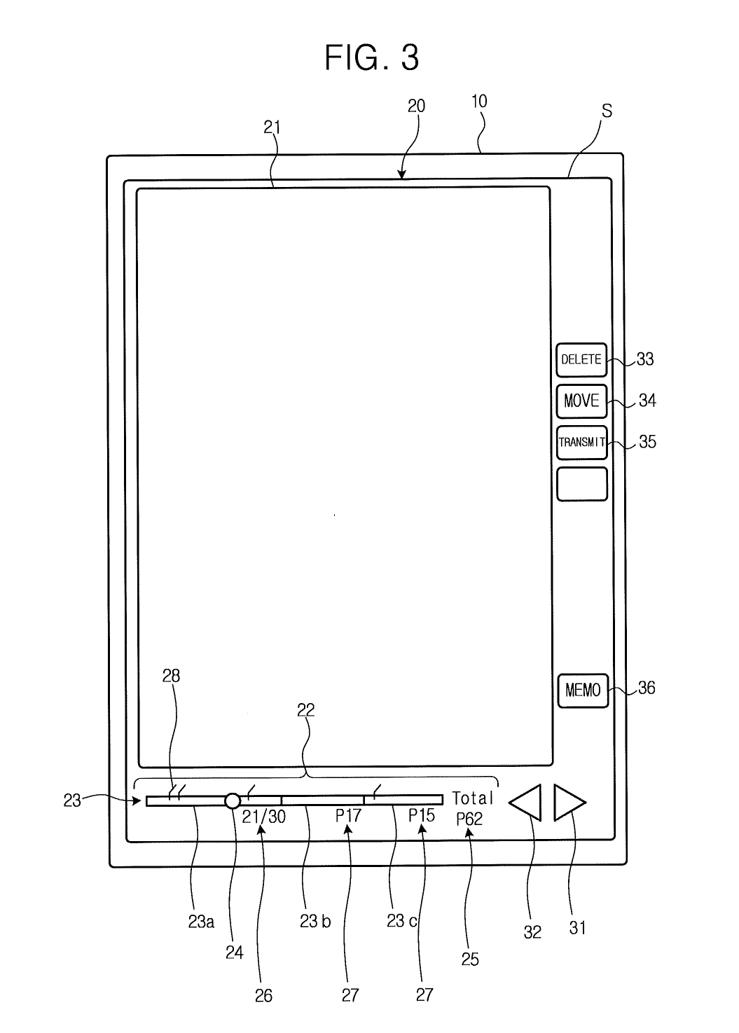

FIG. 3 shows the structure of a standard window 20 to be displayed on the display unit 17 of the document viewing apparatus 10. On the standard window 20, a document display area 21 occupying approximately 80% of the standard window 20 is arranged so as to be aligned to the upper-left corner of the standard window 20. On the document display area 21, any one page of a document to be displayed is displayed.

Below a lower part of the document display area 21, a search information display area 22 is provided for displaying the number of documents registered as the documents to be displayed, the number of pages of each document, a page position of the current displayed page which is currently displayed, and the like and also for receiving a page selecting operation and the like.

In the search information display area 22, a page designation object corresponding to each document to be displayed is displayed. The page designation object is an object for receiving the page designating operation of designating any page in one document. In this embodiment, the page designation object is a stick-like document bar. The full length of the document bar corresponds to one entire document, and a position indicated in the full length represents a page position in the document. The left end of the document bar corresponds to a first page and the right end corresponds to a final page. For example, when a document bar corresponds to a document containing 30 pages, the full length of this document bar corresponds to the entire document containing 30 pages, and a position indicated at one third of the above bar from the left end corresponds to the page position of the tenth page from the first page of the document.

In the example of FIG. 3, a seek bar 23 is displayed as a coupled page designation object formed by coupling document bars (page designation objects) of a plurality of documents to be displayed. The seek bar 23 is formed in a straight stick shape having a fixed full length, and represents the whole of the plurality of documents to be displayed. When there are a plurality of documents to be displayed, the seek bar 23 having a fixed length is divided into a plurality of sections as many as the number of documents. Each section corresponds to one document bar (one page designation object) described above. A ratio of the length of each section corresponds to a ratio of the number of pages of each document to the number of pages of the plurality of documents to be displayed.

In the example of FIG. 3, three documents are registered as documents to be displayed: a first document (30 pages), a second document (17 pages), and a third document (15 pages). The seek bar 23 is divided into three sections: from the left end, a section 23a as a document bar corresponding to the first document, a section 23b as a document bar corresponding to the second document, and a section 23c as a document bar corresponding to the third document. The ratio of each length of the section 23a, the section 23b, and the section 23c is 30:17:15, according to the ratio of the number of pages of each document. The total number of pages of these three documents is 62. When the full length of the seek bar 23 is set to the fixed length L, the section 23a has the length La=L×30/62, the section 23b has the length Lb=L×17/62, and the section 23c has the length Lc=L×15/62.

The above lengths are represented by a general equation. When the fixed length (the full length) of the seek bar 23 denotes L, the number of pages of a document corresponding to a section n denotes Pn, and the total number of pages denotes G, the section n has a length Ln, which is represented by

Ln=L×Pn/G (Equation 1).

Note that the arrangement order of the documents (the sections) in the seek bar 23 are determined so as to arrange the documents from the left end of the seek bar 23 in the order of being registered earlier.

An indicator 24 on the seek bar 23 indicates the position of the current displayed page.

At right of the right end of the seek bar 23, the total number of pages 25 of the whole of the documents to be displayed, which are represented in the seek bar 23, is displayed.

For the document containing the current displayed page among the documents to be displayed, the detailed document information 26 is displayed below the right end of the section corresponding to the document containing the current displayed page. The detailed document information 26 represents the page position of the current displayed page in the document and the number of pages of the document containing the current displayed page, in a fractional form with the number of pages of the document as a denominator. For each of the documents other than the document containing the current displayed page among the documents to be displayed, the number-of-pages information 27 indicating the number of pages of the document is displayed.

Furthermore, a marker 28 is displayed on the seek bar 23 at a position corresponding to a page for which the handwriting is carried out.

At right of the search information display area 22, a forward button 31 for forwardly turning over the current displayed page by one page and a back button 32 for backwardly turning over the current displayed page by one page.

In an area at right of the document display area 21, a delete button 33, a move button 34, a transmission button 35, a memo addition button 36, and the like are vertically arranged.

Next, the transitions of display contents in the search information display area 22 will be described.

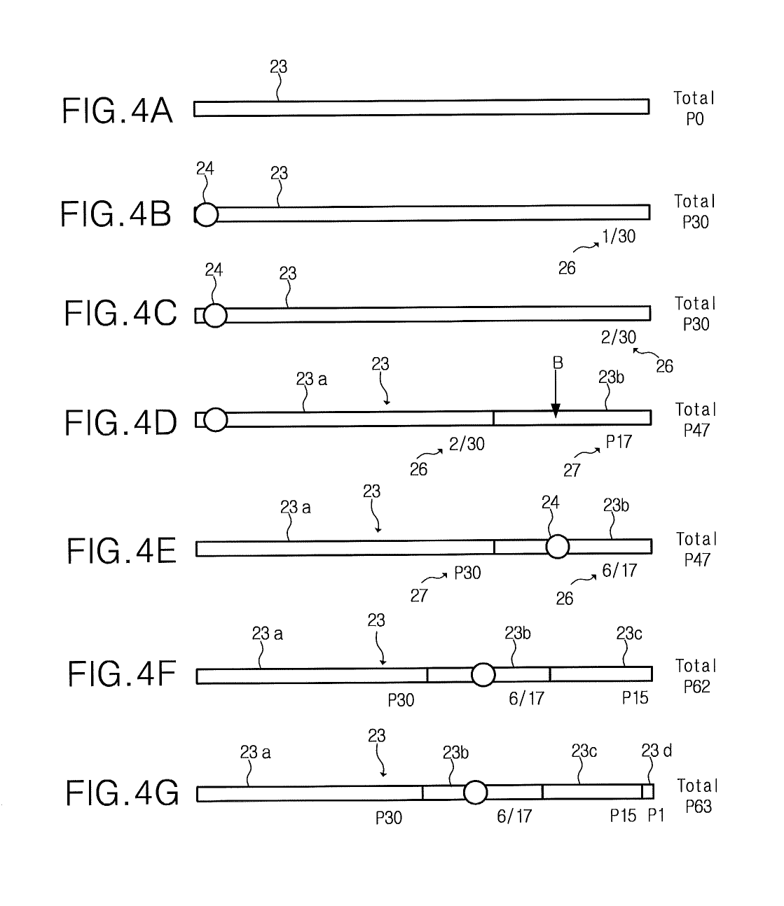

FIGS. 4A to 4G show the transition of the seek bar 23 and the like in case that documents to be displayed are sequentially added from an initial state in which no document to be displayed is present.

FIG. 4A shows a display state of the search information display area 22 in the initial state in which no document to be displayed is registered. The seek bar 23 is displayed as one undivided lateral stick, and the total number of pages 25 is set at “0”. The indicator 24, the detailed document information 26, the number-of-pages information 27, and the marker 28 are not displayed.

FIG. 4B shows a state immediately after a first document to be displayed (the first document having 30 pages) is registered from the initial state. The seek bar 23 is undivided and still has one stick shape. The total number of pages 25 is displayed as “P30”. Immediately after the registration, the first page of this document is displayed in the document display area 21. Therefore, the indicator 24 is positioned at the left end of the seek bar 23, and the detailed document information 26 indicates “1/30”.

FIG. 4C shows the state in which the forward button 31 shown in FIG. 3 is depressed to display the second page. The indicator 24 moves to right by one page and the detailed document information 26 indicates “2/30”.

FIG. 4D shows the state immediately after a second document (the second document having 17 pages) is registered as the document to be displayed. The seek bar 23 is divided into two sections at a ratio of 30:17. The current displayed page is not changed. Since the first section 23a arranged on the left side corresponds to the first document which is firstly registered and the second page of the first document is currently displayed, “2/30” is displayed as the detailed document information 26. The second section 23b arranged on the right side corresponds to the second document, and “P17” is displayed as the number-of-pages information 27.

FIG. 4E shows the state in which the current displayed page is switched by touching any position on the seek bar 23 with a pen. FIG. 4E shows the state in which as a result of touching a position B (a position corresponding to the sixth page of the second document) with a pen in the section 23b corresponding to the second document, which is shown in FIG. 4D, the indicator 24 is moved to the position B. In the section 23b, since the sixth page of the corresponding second document becomes displayed, “6/17” is displayed as the detailed document information 26. On the other hand, in the section 23a, the detailed document information 26 is switched to the number-of-pages information 27 and “P30” is displayed.

As such, only by touching any position on the seek bar 23, a document corresponding to the section including the touched position and a page corresponding to the touched position in the document are designated. Thereby, it is possible to change the current displayed page. That is, even if a plurality of documents to be displayed are present, there is no need to perform a two-step operation in which a document is first selected and a page is then selected in the document. With one operation, a desired page in a desired document can be selected.

FIG. 4F shows the state in which a third document (the third document having 15 pages) is further added as the document to be displayed.

FIG. 4G shows the state immediately after the depression of the memo addition button 36. When the memo addition button 36 is depressed, a blank (white) page is additionally registered as a new document to be displayed. As a result, a new section 23d is added, and the seek bar 23 is divided into four sections 23a to 23d.

As such, the plurality of documents sequentially added as the documents to be displayed are treated as a series of document group in which the documents are arranged in order of the addition (registration). For example, if all documents are selected and transmitted to the information processing apparatus 5 or the like, all documents can be transmitted as one document in which the plurality of documents are grouped, to the information processing apparatus 5.

When the plurality of documents to be displayed are related to each other, the total number of pages of the whole of the plurality of documents, the ratio of the number of pages of each document in the whole of the plurality of documents, the page position in the whole of the plurality of documents, and the like can be intuitively grasped.

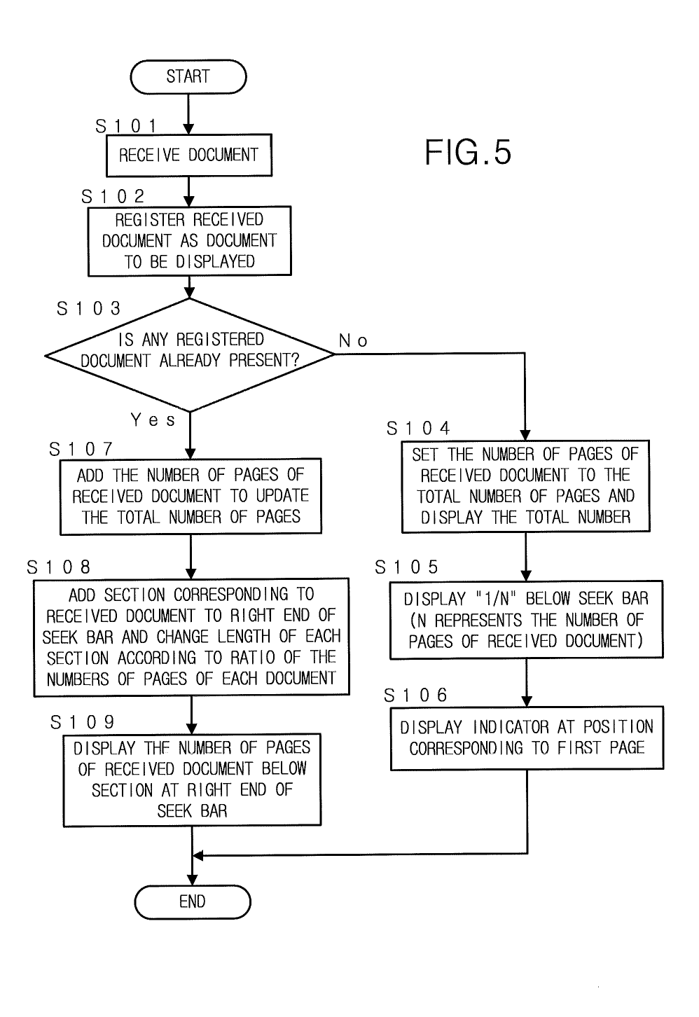

FIG. 5 shows a flowchart of a process of adding a document to be displayed. When the document viewing apparatus 10 receives document data from an external apparatus such as the information processing apparatus 5 (Step S101), the document viewing apparatus 10 registers the received document as the document to be displayed (Step S102). Documents to be displayed are listed in the order of the registration as a series of document group. The received document is registered at the end of this list.

Next, it is checked whether any document which has already registered as the document to be displayed is present other than the document received in Step S101 (Step S103). If no document which has already registered is present (Step S103; No), the seek bar 23 is displayed as shown in FIG. 4B. That is, the number of pages of the received document is set as the total number of pages and is displayed (Step S104), and “1/N” (N is the number of pages of the document received in Step 101) is displayed below the seek bar 23 as the detailed document information 26 (Step S105). Furthermore, the indicator 24 is displayed at the left end of the seek bar 23 (a position corresponding to the first page) (Step S106). Then, the process is ended.

If any document which has already registered as the document to be displayed is present other than the document received in Step S101 (Step S103; Yes), the display contents of the search information display area 22 are changed from those shown in FIG. 4C to those shown in FIG. 4D or to any of FIG. 4E and FIG. 4F. That is, the number of pages of the document received in Step S101 is added to update the total number of pages (Step S107), a section corresponding to the document received in Step S101 is added to the right end of the seek bar 23, and the length of each section on the seek bar 23 is changed according to the ratio of the number of pages of each document. Then, the updated display contents in the search information display area 22 are displayed (Steps S108 and S109). Specifically, by using Equation 1 described above, the length of each section is calculated and updated.

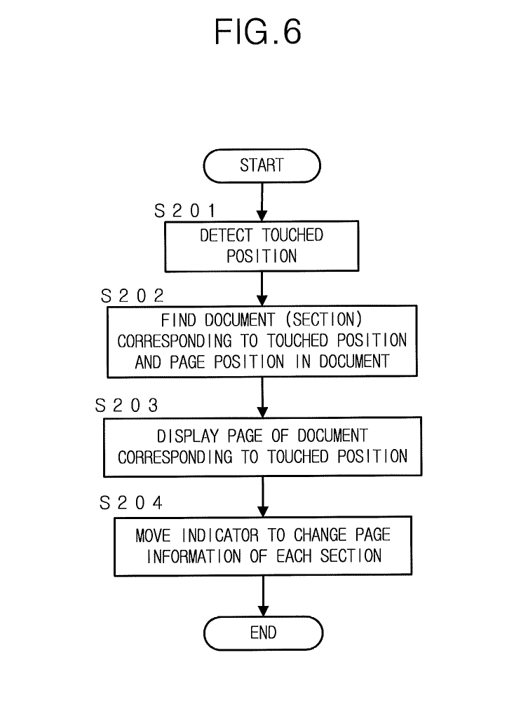

FIG. 6 is a flowchart of a process of changing the current displayed page by receiving, the touch operation on the seek bar 23. When the document viewing apparatus 10 receives the touch operation on the seek bar 23, the document viewing apparatus 10 detects a touched position (Step S201). Next, a document corresponding to the touched position and a page position in the document are found (Step S202).

Then, the found page of the found document is displayed in the document display area 21 (Step S203). Next, the display contents of the search information display area 22 are changed from FIG. 4D to FIG. 4E. That is, the indicator 24 is moved to the position corresponding to the displayed page. Regarding the section of the document containing the current displayed page, the detailed document information 26 is displayed. Regarding the sections of the other documents, the number-of-pages information 27 is displayed (Step S204). Then, the process is ended.

Next, the case in which all documents are deleted will be described.

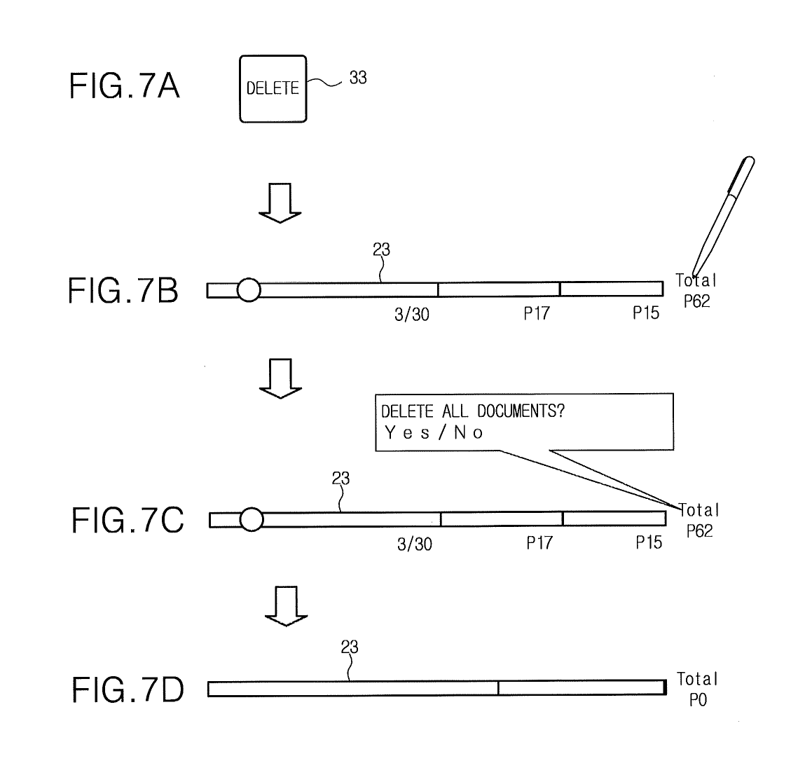

FIGS. 7A to 7D show a user procedure in case that all documents registered as the documents to be displayed are deleted and the transition of a display state in the search information display area 22. First, the user depresses the delete button 33 (FIG. 7A). Next, the user touches the display position of the total number of pages 25 in the search information display area 22 (FIG. 7B).

Upon this operation, a confirmation message is displayed, such as “DELETE ALL DOCUMENTS? YES/NO” (FIG. 7C). When the user selects “YES” for this inquiry, all documents are deleted.

FIG. 7D shows a display state in the search information display area 22 after all documents are deleted. The state becomes similar to the initial state in FIG. 4A.

Next, the case in which a document or a page to be displayed is deleted will be described.

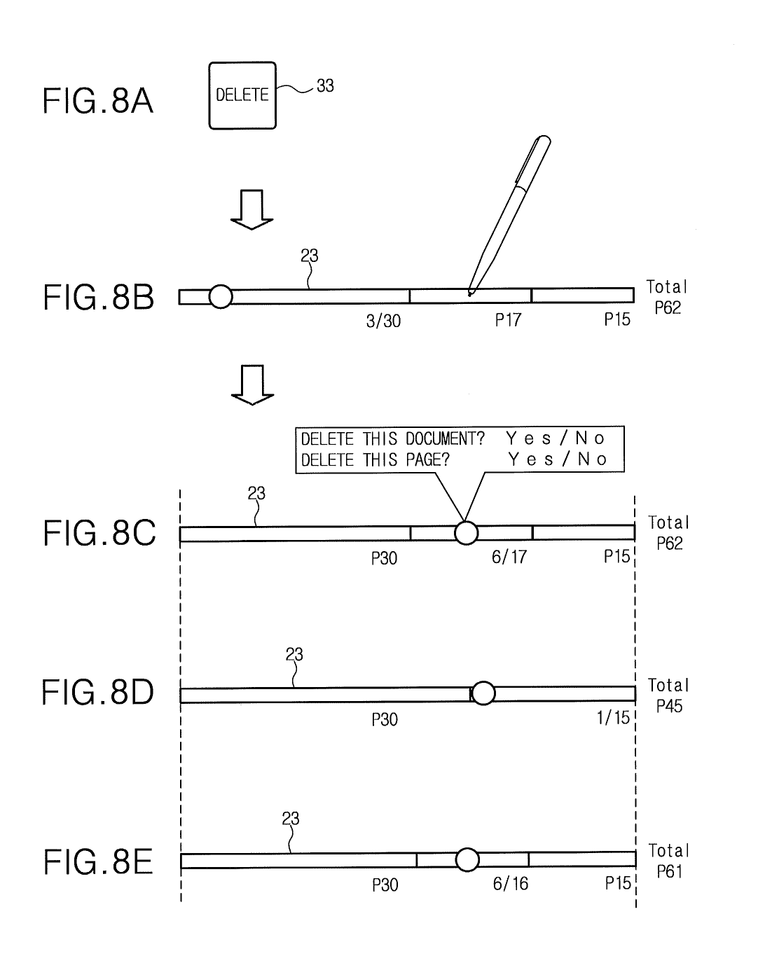

FIGS. 8A to 8E show a user procedure in case that any of documents or pages to be displayed is deleted and the transition of a display state in the search information display area 22. First, the user depresses the delete button 33 (FIG. 8A), and then touches a position corresponding to a document or a page to be deleted on the seek bar 23 (FIG. 8B).

Upon this operation, a confirmation message is displayed, such as “DELETE THIS DOCUMENT? YES/NO; DELETE THIS PAGE? YES/NO” (FIG. 8C). When the user selects “YES” corresponding to the document deletion for this inquiry, the document corresponding to the section containing the touched position is deleted. FIG. 8D shows a display state in the search information display area 22 after the document corresponding to the touched position is deleted.

When the user selects “YES” corresponding to the page deletion for the inquiry shown in FIG. 8C, the page corresponding to the touched position is deleted. FIG. 8E shows a display state in the search information display area 22 after the page corresponding to the touched position is deleted.

As shown with broken lines of FIGS. 8C to 8E, the length of the entire seek bar 23 is not changed even though the document or the page is deleted.

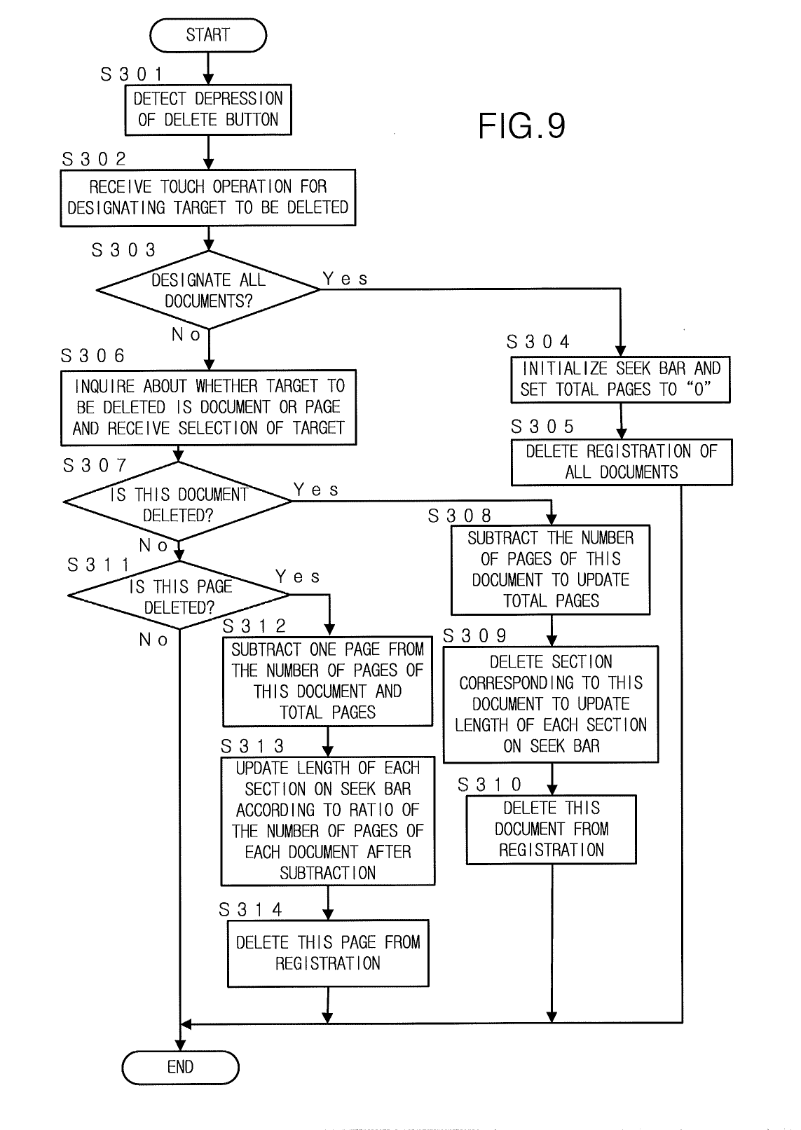

FIG. 9 shows a flowchart of the deleting process to be performed by the document viewing apparatus 10. When the operating unit 13 detects that the depression of the delete button 33 (Step S301), the document viewing apparatus 10 receives the touch operation for designating a target to be deleted (Step S302). Specifically, in the case of deleting all documents, an operation of touching the display position of the total number of pages 25 is received. In the case of deleting a document or a page, an operation of touching a position corresponding to the document or the page to be deleted on the seek bar 23 is received.

When the operation of touching the total number of pages 25 is received, that is, when the instruction for deleting all documents is received (Step S303; Yes), the seek bar 23 is initialized to set the total number of pages 25 to “0” (Step S304). Then, all documents are deleted from the registration of the documents to be displayed, and data of all documents is also deleted from the memory (Step S305). The process is ended.

When the seek bar 23 is touched (Step S303; No), the document viewing apparatus 10 inquires of the user about whether the target to be deleted is a document or a page (Step S306).

When the operation for deleting a document is received (Step S307; Yes), the document corresponding to the touched position is regarded as the document to be deleted, and the number of pages of the document to be deleted is subtracted to update the total number of pages 25 (Step S308). Furthermore, a section corresponding to the document to be deleted is deleted from the seek bar 23 and, for example, the length of each of the remaining sections is changed according to the ratio of the number of pages of the document corresponding to the section. Thereby, the display contents in the search information display area 22 are updated (Step S309). Then, the document to be deleted is deleted from the registration (list) of the documents to be displayed, and data of the document is deleted from the memory (Step S310). The process is ended.

When the operation for deleting a page is received (Step S307; No and Step S311; Yes), the page corresponding to the touched position is regarded as the page to be deleted, and the number of pages of the document containing the page to be deleted and the total number of pages 25 are updated by subtracting “1” therefrom (Step S312). Furthermore, for example, the length of each section is changed according to the ratio of the number of pages of each document after the subtraction. Thereby, the display contents in the search information display area 22 are updated (Step S313). Then, the page to be deleted is deleted from the registration of the pages to be displayed, and data of the page is deleted from the memory (Step S314). The process is ended.

As such, only by touching any position on the seek bar 23, a page corresponding to the touched position can be selected as the page to be deleted. Thus, even if a plurality of documents to be displayed are present, a desired page in a desired document can be selected as the page to be deleted without performing a two-step operation in which a document is first selected and a page is then selected in the document.

Next, the process of changing the arrangement order by moving a document or a page registered as the document or the page to be displayed will be described.

As described above, the documents are regarded as a series of document group in which the documents are listed in the order of receiving the documents from the external apparatus (in the registration order), and are arranged from the left end of the seek bar 23 in a right direction. In the document viewing apparatus 10, the arrangement order of documents and pages listed in the registration order can be changed by moving the document or the page.

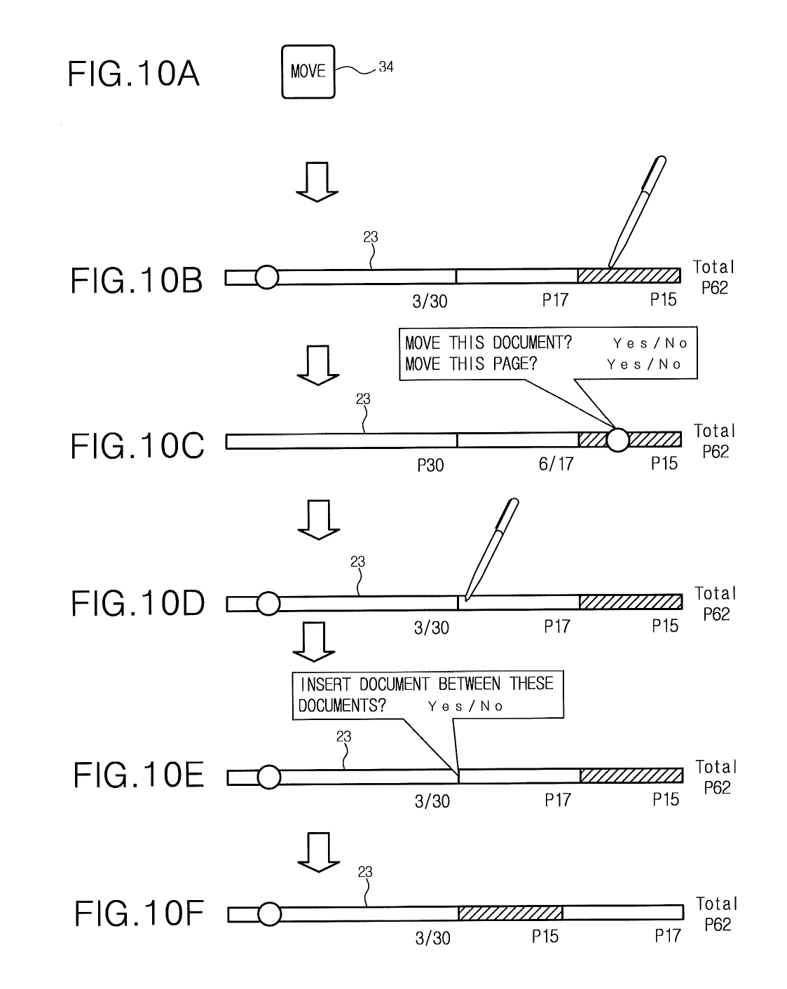

FIGS. 10A to 10F show a user procedure in case that a document or a page registered as the document or the page to be displayed is moved and the transition of a display state in the search information display area 22. Firstly, the user depresses the move button 34 (FIG. 10A), and then touches a position corresponding to a document or a page to be moved on the seek bar 23 (FIG. 10B).

Upon this operation, a confirmation message is displayed, such as “MOVE THIS DOCUMENT? YES/NO”; MOVE THIS PAGE? YES/NO″ (FIG. 10C). Upon this inquiry, the user selects “YES” corresponding to the document movement or “YES” corresponding to the page movement.

Next, the user touches a position corresponding to the movement destination on the seek bar 23 (FIG. 10D). Here, when “YES” corresponding to the document movement is depressed in response to the confirmation message described above, the document viewing apparatus 10 sets a boundary position closest to the touched position among boundary positions between the sections (including the left and right ends of the seek bar 23), to the movement destination. Further, the document viewing apparatus 10 displays a message “INSERT DOCUMENT BETWEEN THESE DOCUMENTS? YES/NO” while the document viewing apparatus 10 indicates the movement destination (FIG. 10E). Here, when the user selects “YES”, the document to be moved is moved between documents (or moved to the front end or the rear end of the document group) corresponding to the movement destination (FIG. 10F). FIG. 10B to FIG. 10F show the case of moving a document, and a section corresponding to the document to be moved is hatched.

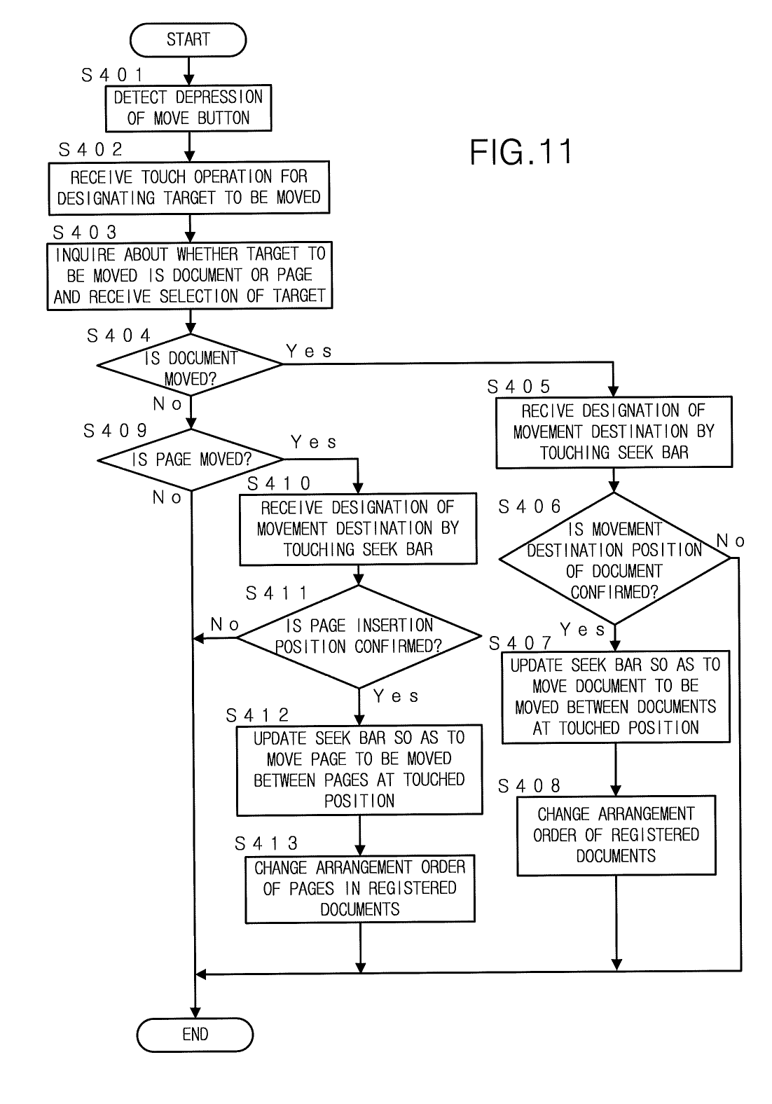

FIG. 11 shows a flowchart of the moving process to be performed by the document viewing apparatus 10. When the operating unit 13 detects the depression of the move button 34 (Step S401), the document viewing apparatus 10 receives the touch operation for designating a target to be moved (Step S402). Specifically, a touch operation which is performed at the position corresponding to the target on the seek bar 23 is received.

Next, the document viewing apparatus 10 inquires of a user about whether the target to be moved is a document or a page (Step S403).

When an operation for moving a document is received (Step S404; Yes), the document viewing apparatus 10 receives the movement destination by touching the seek bar 23, and sets a boundary position closest to the touched position among boundary positions between sections (including the left and right ends of the seek bar 23), to the movement destination (Step S405).

Next, the document viewing apparatus 10 indicates the set movement destination and inquires of the user about whether the document is moved to the set movement destination (Step S406). When the selection of “NO” is received upon this inquiry (Step S406; No), the process is ended. When the selection of “YES” is received upon this inquiry (Step S406; Yes), the section corresponding to the document to be moved is moved on the seek bar 23 so as to insert the document to be moved at the movement destination between documents or the like (Step S407). Also, the arrangement order of the documents listed and registered in the memory is changed according to the above operations (Step S408), and the process is ended.

When an operation of moving a page is received (Step S404; No and Step S409; Yes), the document viewing apparatus 10 receives the movement destination by touching the seek bar 23, and sets a boundary position between pages, which is closest to the touched position, to the movement destination (Step S410).

Next, the document viewing apparatus 10 indicates the set movement destination and inquires of the user about whether the page is moved to the set movement destination (Step S411). When the selection of “NO” is received upon this inquiry (Step S411; No), the process is ended. When the selection of “YES” is received upon this inquiry (Step S411; Yes), the display contents in the seek bar 23 are changed so as to insert the page to be moved at the movement destination between pages (Step S412).

Specifically, if the position of the page to be moved and the movement destination of the page to be moved are in the same document, the sections are not moved. If the position of the indicator 24 is required to be moved by the movement of the page, the position of the indicator 24 is changed. On the other hand, if a page is moved to another document, the seek bar 23 is changed so as to shorten the section corresponding to the document including the page to be moved, by one page, and to lengthen the section corresponding to the document to which the page is moved, by one page. Also, the display position of the indicator 24, the detailed document information 26, and the like are changed as required.

Then, the arrangement order of pages in the documents registered in the memory is changed (Step S413), and the process is ended.

As such, only by touching any position on the seek bar 23, a document or a page corresponding to the touched position can be selected as the document or the page to be moved and the position of the movement destination can be designated. Thus, even if a plurality of documents to be displayed are present, a desired page in a desired document can be selected as the page to be moved and the movement destination of the page to be moved can be designated, without performing a two-step operation in which a document is first selected and a page is then selected in the document.

Next, the transmission of a document or a page will be described.

In this embodiment, the selected document or the selected page is transmitted to a transmission source apparatus which transmits the above document or the above page when the above document or the above page is registered in the document viewing apparatus 10.

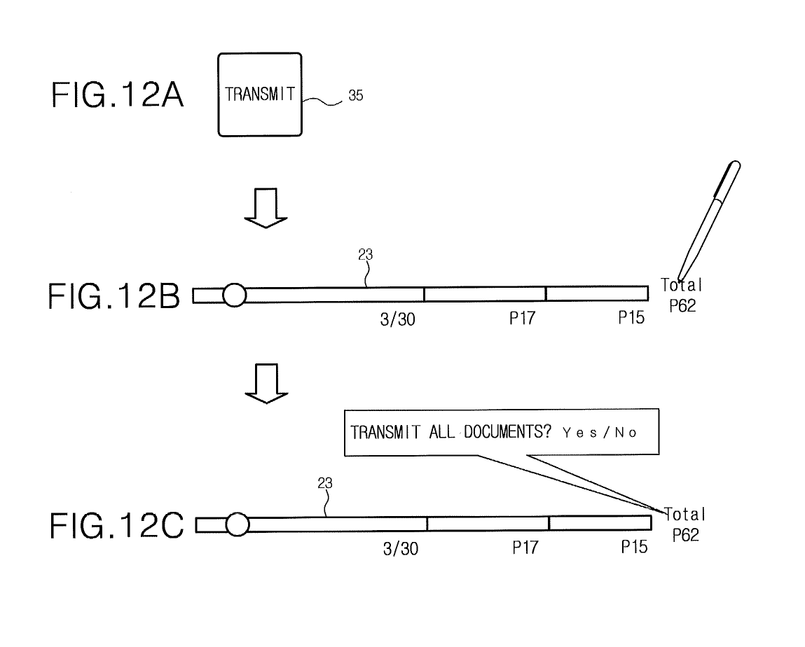

FIGS. 12A to 12C show a user procedure in case that all documents registered as the documents to be displayed are transmitted to an external apparatus and the transition of a display state in the search information display area 22. First, the user depresses the transmission button 35 (FIG. 12A), and then touches the display position of the total number of pages 25 in the search information display area 22 (FIG. 12B).

Upon this operation, a confirmation message is displayed, such as “TRANSMIT ALL DOCUMENTS? YES/NO” (FIG. 12C). When the user selects “YES” upon this inquiry, all documents are transmitted.

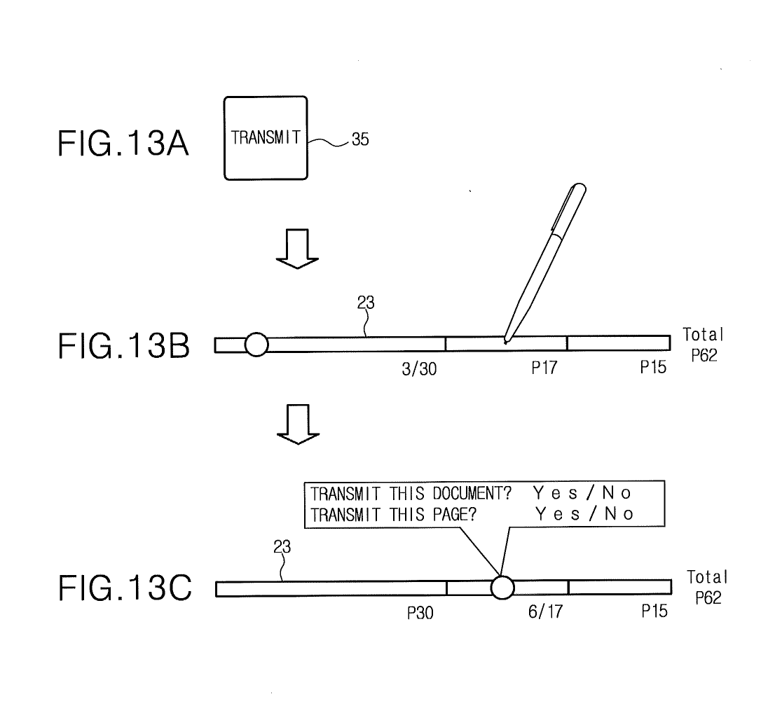

FIGS. 13A to 13C show a user procedure in case that any of documents or pages to be displayed is transmitted to an external apparatus and the transition of a display state in the search information display area 22. First, the user depresses the transmission button 35 (FIG. 13A), and then touches a position corresponding to a document or a page to be transmitted on the seek bar 23 (FIG. 13B)

Upon this operation, a confirmation message is displayed, such as “TRANSMIT THIS DOCUMENT? YES/NO; TRANSMIT THIS PAGE? YES/NO” (FIG. 13C). When the user selects “YES” corresponding to the document transmission upon this inquiry, the document corresponding to a section including the touched position is transmitted.

When the user selects “YES” corresponding to the page transmission for this inquiry shown in FIG. 13C, the page corresponding to the touched position is transmitted.

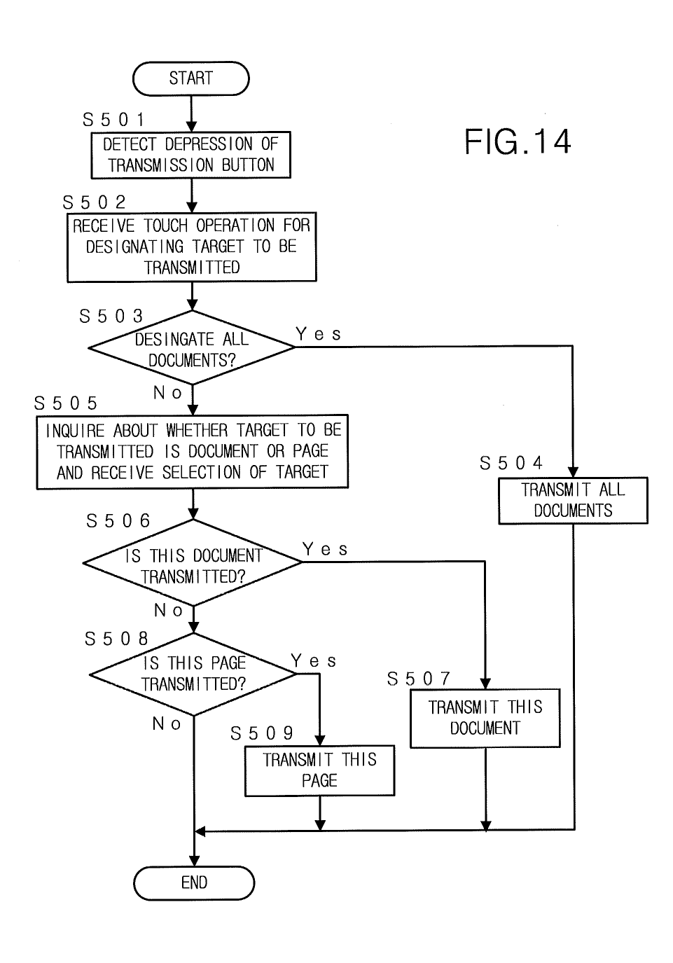

FIG. 14 shows a flowchart of the transmitting process to be performed by the document viewing apparatus 10. When the operating unit 13 detects the depression of the transmission button 35 (Step S501), the document viewing apparatus 10 receives the touch operation for designating a target to be transmitted (Step S502). Specifically, in the case of transmitting all documents, an operation of touching the display position of the total number of pages 25 is received. In the case of transmitting a document or a page, an operation of touching a position corresponding to the document or the page to be transmitted on the seek bar 23 is received.

When the operation of touching the total number of pages 25 is received, that is, when the instruction for transmitting all documents is received (Step S503; Yes), all documents are transmitted (Step S504) and the process is ended.

When the seek bar 23 is touched (Step S503; No), the document viewing apparatus 10 inquires of the user about whether the target to be transmitted is a document or a page (Step S505).

When the operation for transmitting a document is received (Step S506; Yes), the document corresponding to the touched position is transmitted (Step S507) and the process is ended.

When the operation for transmitting a page is received (Step S506; No and Step S508; Yes), the page corresponding to the touched position is transmitted (Step S509) and the process is ended.

As such, only by touching any position on the seek bar 23, a page corresponding to the touched position can be selected as the page to be transmitted. Thus, even if a plurality of documents to be displayed are present, a desired page in a desired document can be selected as the page to be transmitted without performing a two-step operation in which a document is first selected and a page is then selected in the document.

Next, various modified examples of the display form of the document bar will be described.

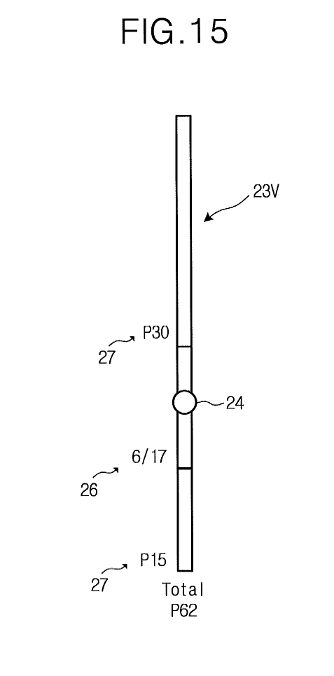

FIG. 15 shows a vertical seek bar 23V. For example, when the document viewing apparatus 10 is used in the landscape orientation, the vertical seek bar 23 is preferably displayed at the right end of the display surface.

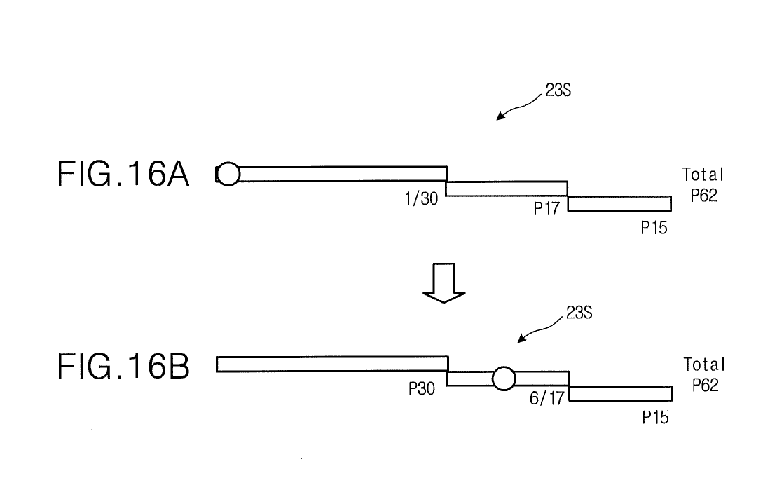

FIGS. 16A and 16B show a step-like seek bar 23S having sections arranged in a stepwise manner. When any position is touched, the indicator 24 moves over a step to the touched position (from FIG. 16A to FIG. 16B).

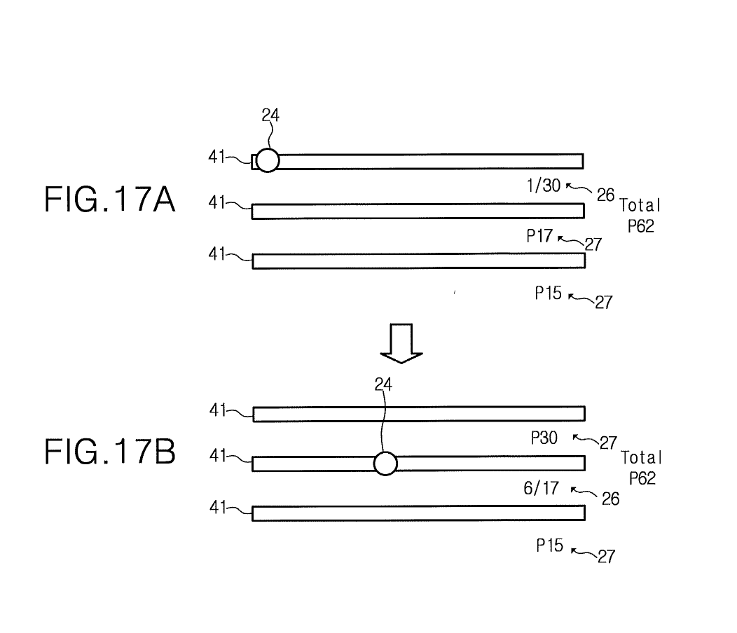

FIGS. 17A and 17B show the case in which independent document bars 41 are displayed for the respective documents. In this example, three document bars 41 corresponding to three documents are displayed in parallel. Also, regardless of the number of pages of each document, the lengths of the document bars 41 are the same. When any position on any document bar 41 is touched, the indicator 24 moves over the space between the document bars 41 to the touched position (from FIG. 17A to FIG. 17B).

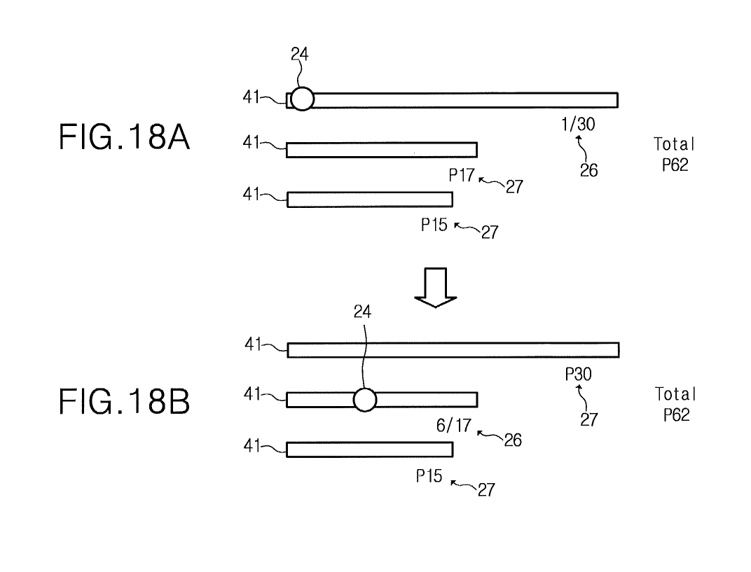

FIGS. 18A and 18B show the case in which independent document bars 41 are displayed for the respective documents and each document bar 41 has a length according to the number of pages of each document. For example, the length of the document bar 41 of a document having the largest number of pages among the plurality of documents to be displayed is set to a predetermined maximum length, and the length of each of the document bars 41 is set so as to match the ratio of the number of pages of each document. Also in this case, when any position on any document bar 41 is touched, the indicator 24 moves over the space between document bars to the touched position (from FIG. 18A to FIG. 18B).

As such, the document bars 41 are not necessarily coupled so as to be one stick like the seek bar 23, and may be displayed independently from each other.

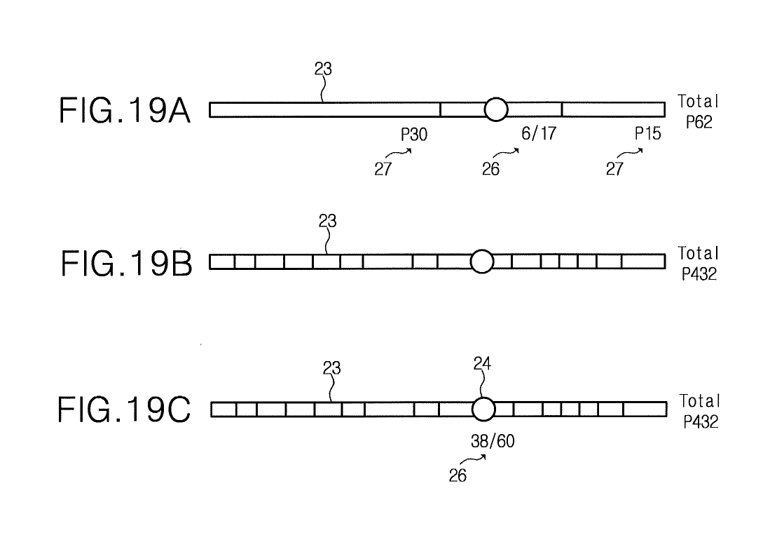

FIGS. 19A to 19C show the seek bar 23 in case that the detailed document information 26 and the number-of-pages information 27 for each document are omitted when many documents to be displayed are present. FIG. 19A shows a normal state in which the number of sections is small and the detailed document information 26 and the number-of-pages information 27 are displayed for each section. FIG. 19B shows a display example in case that the number of sections exceeds a predetermined number (for example, 10).

In case that the number of documents registered as the documents to be displayed is increased and the number of sections is also increased, when the detailed document information 26 and the number-of-pages information 27 are displayed for each section, it is difficult to view the above information. Therefore, when the number of sections exceeds a predetermined number, as shown in FIG. 19B, the detailed document information 26 and the number-of-pages information 27 are omitted. The total number of pages 25 is maintained.

As shown in FIG. 19C, the detailed document information 26 may be displayed for a section where the indicator 24 is displayed, even if the number of sections exceeds the predetermined number.

Also, the documents registered as the documents to be displayed may be grouped on the condition that a predetermined common requirement is satisfied in the registered documents, and the document bar or the section in the seek bar 23 may be displayed for each group. This is particularly effective when the number of documents is large. Examples of the requirements which are the standards for grouping the documents include the date or the time zone when the document is received from an external apparatus (the date or the time zone when the document is registered as the document to be displayed), a document transmission source (a transmitter who transmits the document to the document viewing apparatus 10 or a terminal device which transmits the document), and the transmission destination to which the document is transmitted. Any requirement other than the requirements described above may be used. Also, the group of the documents may be cancelled, or the group of the documents may be cancelled so as to divide the group into the respective designated groups. By cancelling the group, each document can be deleted, moved, and transmitted.

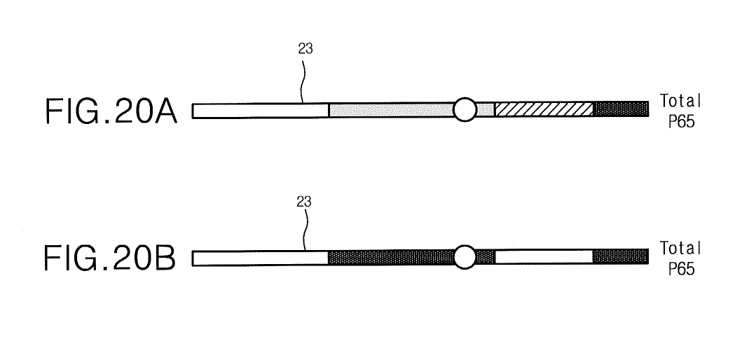

The colors of the sections on the seek bar 23 may be varied so as to enable each boundary between sections to be recognized. In this case, the colors of all sections may be varied as shown in FIG. 20A or at least the colors of the adjacent sections may be varied as shown in FIG. 20B. By coloring the sections, the seek bar 23 can be displayed so as to easily recognize the sections visually.

As described above, the embodiment and the modified examples are explained by using the drawings. However, in the present invention, the concrete configuration is not limited to the above embodiment and the like. In the present invention, various modifications of the above embodiment and the like or the addition of various functions or the like to the embodiment and the like can be carried out without departing from the gist of the invention.

In the embodiment, the memory-type display device is used as the display unit 17. However, a liquid crystal display may be used. The display contents may be displayed in color or monochrome. However, in the case of the seek bar 23 displayed by using various colors as shown in FIGS. 20A and 20B, it is required for the display unit to display the various colors for the seek bar 23.

The display form of the page designation object is not restricted to those exemplified in the embodiment and the like. For example, the scale markings for each page (for each group including the predetermined number of pages in case that the number of pages is large) may be added to the document bar 41 and the seek bar 23. Also, the page designation object may be an enter box for accepting the designation of a page position by entering the number. As a page designation object corresponding to a plurality of documents, a plurality of enter boxes may be displayed. Further, when the number is entered in any one of the enter boxes, the page which is contained in the document corresponding to the enter box in which the number is entered, and which is arranged at the page position corresponding to the entered number, may be displayed or may be processed.

The page designation object is not restricted to the stick-like document bar 41 or the like, and may be the display contents having any shape, such as circle, ring, arc, or V-shape. For example, the page designation object may be displayed as an arc, the coupled page designation object may be displayed as a circle, the size of the circle may be fixed, and the central angle of the arc may be set according to the ratio of the number of pages of the document corresponding to the arc.

In the embodiment, in the operations for deleting, moving, and transmitting the document or the like, the document viewing apparatus 10 inquires of the user about whether the target to be processed is a document or a page when the seek bar 23 is touched after the type (designation) of the operation (the deletion, the movement, or the transmission of the document or the like) is received. However, for example, without the above inquiry as described above, the designated process may be performed for a page corresponding to the touched position. Also, as buttons for designating a process, a button for each document and a button for each page may be separately provided, such as a button for deleting each document and a button for deleting each page. Thereby, for example, after the button for instructing the deletion of each page is operated, by only one operation of touching the seek bar 23, any page in any document can be selected as the page to be deleted from among the plurality of documents registered as the documents to be displayed.

When the touch of the seek bar 23 is detected, the page information corresponding to the touch (such as the page number) may be displayed. When the touched position is moved in the situation that the seek bar 23 is touched, the information indicating the page position corresponding to the touched position which is moved may be sequentially displayed. When the touch is released, the released position may be determined as the position which is finally selected by the user. Thereby, the page to be displayed or processed may be determined.

For example, when the eighth page of the document containing 30 pages is displayed, there is some possibility that the portion corresponding to the eighth page is not accurately touched. However, in case that the user I/F described above is provided, even if the first touched position is slightly out of the intended page, the user moves the depressed position in the situation in which the seek bar 23 is touched while the user views the page information. Thereby, the intended page can be designated without performing the operation again or without additionally switching the page by using the forward button 31 or the back button 32. The length for each page on the seek bar 23 may be lengthened near the touched position only during the touch of the seek bar 23. Thereby, the operation for moving the touched position to the position corresponding to the intended page after the seek bar 23 is touched, is facilitated.

The document contents are not restricted to characters, and may be image information or the like.

In the embodiment, the case in which one page is displayed in the document display area is exemplified. However, the present invention is applied also to the case in which a plurality of consecutive pages (for example, a two-page spread) are displayed at once. In this case, the plurality of pages to be displayed or processed can be defined with reference to the position on which the seek bar 23 or the document bar is touched.

In the embodiment, the document viewing apparatus 10 in which the handwriting input can be performed is exemplarily explained. However, the editing function or the handwriting function is not necessarily required. In the document viewing apparatus, it is only necessary have the function of displaying the document.

In the embodiment, the document viewing apparatus 10 is a portable terminal device. However, a stationary apparatus can be used as the document viewing apparatus 10.

In the embodiment, the document received from the external apparatus is regarded as the document to be displayed. However, any method of selecting the document to be displayed can be applied. For example, from among many documents stored in the hard disk drive or the like, a plurality of any documents can be selected as the documents to be displayed. When a plurality of documents are simultaneously opened by using a predetermined application, the plurality of opened documents may be regarded as “documents registered as the documents to be displayed” in the embodiment.

One of the objects of the above embodiment and the like is to provide a document viewing apparatus and a tangible computer-readable recording medium which stores a program therefor which can switch a page to be displayed to any page in any document among a plurality of documents to be displayed by one-step designating operation.

In the embodiment and the like, the page designation objects are displayed for a plurality of documents to be displayed, respectively. When the page designating operation is received for any one of the page designation objects, the control unit instructs the display unit to display the page designated by the page designating operation and contained in the document corresponding to the page designation object for which the page designating operation is received. Any page designation object is used as long as the page designating operation can be received for the page designation object. For example, the page designation object may be a stick-like object in which the page position is indicated or may be an object for which the page designating operation can be directly received by using the number.

In the embodiment and the like, the entire page designation object corresponds to one document and the page position in the one document is specified by the position indicated in the page designation object. Examples of the shape of the page designation object include a bar, a ring and an arc. The page designating operation is an operation of selecting any portion in the page designation object. Thereby, the desired page position can be simply and intuitively designated.

In the embodiment and the like, the identification mark is displayed at the page position of the page designation object corresponding to the document containing the page which is currently displayed, among a plurality of page designation objects. It is possible to intuitively recognize the page position of the page which is currently displayed and the document containing the page at a glance.

In the embodiment and the like, the page designation objects corresponding to a plurality of documents respectively are coupled so as to enable each boundary between the page designation objects to be recognized, and are displayed as one coupled page designation object. A plurality of documents can be integrally displayed, and any page in any document can be designated on the integrated display contents.

In the embodiment and the like, the entire coupled page designation object has a constant size, and each size of the page designation objects constituting the coupled page designation object is set according to the ratio of the number of pages of the document corresponding to each page designation object. For example, when the page designation objects and the coupled page designation object are bar-like display contents, the full length of the coupled page designation object as one bar is set to a fixed length, and the length of the portion (referred to as the section) corresponding to each page designation object is set according to the ratio of the number of pages of each document.

In the embodiment and the like, the page designation objects constituting the coupled page designation object are arranged in the order of setting the document corresponding to the page designation object, to the document to be displayed. Thereby, the order of setting the documents to the documents to be displayed can be recognized from the arrangement order in the coupled page designation object.

In the embodiment and the like, the full length of the page designation object having the stick form indicates the entire document, and the page position in the document is specified by a position indicated in the stick-formed page designation object. In this case, the coupled page designation object is preferably formed in one straight stick-like shape.

In the embodiment and the like, the page position of the page which is currently displayed and the total number of pages of the document containing the page which is currently displayed, are displayed for the document containing the above page. On the other hand, only the total number of pages of the document is simply displayed for the other document.

In the embodiment and the like, when the page designating operation is received after the operation for designating a process such as deletion, transmission and the like is received, the designated process is performed for the designated page. The high operability according to the embodiment and the like in which a desired page in a desired document among a plurality of documents can be selected by one-step designating operation, is applied also to the processes other than the process of switching the page which is currently displayed.

In the embodiment and the like, both of the operation for designating the target to be processed page by page and the operation for designating the target to be processed document by document can be received.

In the embodiment and the like, the document is set to the document to be displayed when the data of the document is input from the external apparatus.

In the embodiment and the like, a new page prepared by the apparatus is treated as one document, and the page designation object corresponding to the new page is displayed. When new pages are prepared a plurality of number of times, the plurality of the new pages prepared by the apparatus may be treated as one document or as individual documents.

In the embodiment and the like, when the number of page designation objects is large, the first page information (the page position of the page which is currently displayed and the number of pages of the document containing the above page) or the second page information (the number of pages of the other document) is not displayed in order to easily view the page designation objects and secure the display area for the document.

In the embodiment and the like, a plurality of documents in which the predetermined common requirement is satisfied are grouped and are displayed as one page designation object. Thereby, the number of page designation objects can be reduced. In particular, when many documents to be displayed are present, the problem in which there is difficulty in viewing the page designation objects due to a large number of the page designation objects can be avoided.

In the embodiment and the like, each of the page designation objects which are coupled with each other, can be easily recognized.

In the embodiment and the like, the user can check the state of the page designation object and that of the coupled page designation object even after the document viewing apparatus is powered off.

According to the document viewing apparatus and the tangible computer-readable recording medium according to the above embodiment and the like, by the one-step selecting operation, the displayed page can be switched to any page of any document among a plurality of documents to be displayed.

The present U.S. patent application claims the priority of Japanese Patent Application No. 2012-94005, filed on Apr. 17, 2012, according to the Paris Convention, and the above Japanese Patent Application is the basis for correcting mistranslation of the present U.S. patent application.

What is claimed is:

1. A document viewing apparatus comprising:
a display unit to display a page designation object for receiving designation of a document or designation of any page in one document;
an operating unit to receive a page designating operation for the page designation object; and
a control unit;
wherein in case that there are a plurality of documents to be displayed, the control unit instructs the display unit to display the page designation objects corresponding to the plurality of documents to be displayed, respectively, and when the operating unit receives the page designating operation for any one of the page designation objects which are currently displayed, the control unit instructs the display unit to display a page designated by the page designating operation, the designated page being contained in a document corresponding to the page designation object for which the page designating operation is received.

2. The document viewing apparatus of claim 1, wherein the entire page designation object corresponds to one document, and a page position in the one document is specified by a position indicated in the page designation object, and
the page designating operation is an operation of selecting any portion in the page designation object.

3. The document viewing apparatus of claim 2, wherein the control unit indicates the display unit to display a predetermined identification mark in the page designation object corresponding to the document containing the page which is currently displayed, the predetermined identification mark being displayed at a position corresponding to the page which is currently displayed.

4. The document viewing apparatus of claim 2, wherein the control unit instructs the display unit to display the page designation objects corresponding to the plurality of documents to be displayed, respectively, as one coupled page designation object formed by coupling the page designation objects so as to enable each boundary between the page designation objects to be recognized.

5. The document viewing apparatus of claim 4, wherein the coupled page designation object has a constant size, and each size of the page designation objects corresponding to the plurality of documents is set according to a ratio of the number of pages of each document to the numbers of pages of the plurality of documents to be displayed.

6. The document viewing apparatus of claim 4, wherein the control unit instructs the display unit to display the coupled page designation object formed by arranging the page designation objects in an order of setting the document corresponding to the page designation object, to the document to be displayed.

7. The document viewing apparatus of claim 1, wherein the page designation object has a stick form, a full length of the page designation object corresponds to one entire document, and a page position in the one entire document is specified by a position indicated in the page designation object.

8. The document viewing apparatus of claim 1, wherein the control unit instructs the display unit to display first page information for the document containing the page which is currently displayed on the display unit, among the plurality of documents to be displayed, and
the control unit instructs the display unit to display second page information for the other document among the plurality of documents to be displayed,
wherein the first page information indicates a page number of the page which is currently displayed on the display unit and the number of pages of the document containing the page which is currently displayed, so as to relate the page number and the number of pages of the document containing the page which is currently displayed, to the page designation object corresponding to the document containing the page which is currently displayed, and
wherein the second page information indicates the number of pages of the other document so as to relate the number of pages of the other document to the page designation object corresponding to the other document.

9. The document viewing apparatus of claim 1, wherein when the operating unit receives the page designating operation for any one of the page designation objects which are currently displayed after the operating unit receives an operation for designating a process for processing the page designated by the page designating operation, the control unit performs the designated process for the page which is designated by the page designating operation and which is contained in the document corresponding to the page designation object for which the page designating operation is received.

10. The document viewing apparatus of claim 1, wherein when the operating unit receives an operation for designating a process, an operation for designating a target to be processed page by page and the page designating operation for any one of the page designation objects which are currently displayed, the control unit performs the designated process for the page which is designated by the page designating operation and which is contained in the document corresponding to the page designation object for which the page designating operation is received; and
when the operating unit receives the operation for designating the process, an operation for designating a target to be processed document by document and the page designating operation for any one of the page designation objects which are currently displayed, the control unit performs the designated process for the entire document corresponding to the page designation object for which the page designating operation is received.

11. The document viewing apparatus of claim 1, further comprising an input unit to input data of the document from an external apparatus,
wherein when the input unit inputs the data of the document, the control unit sets the document including the data input by the input unit, to the document to be displayed.

12. The document viewing apparatus of claim 11, wherein when the operating unit receives a request for preparing a new page, the control unit sets the new page to the document to be displayed and instructs the display unit to display the page designation object corresponding to the new page.

13. The document viewing apparatus of claim 8, wherein when the number of the documents to be displayed exceeds a predetermined number, the control unit instructs the display unit to display neither the first page information nor the second page information, or not to display the second page information.

14. The document viewing apparatus of claim 1, wherein among the plurality of documents to be displayed, the plurality of documents in which a predetermined common requirement is satisfied are grouped and are displayed as one page designation object.

15. The document viewing apparatus of claim 14, wherein the predetermined common requirement includes at least one of a date on which the document is registered as the document to be displayed, a transmission source which transmits the document, and a transmission destination to which the document is transmitted.

16. The document viewing apparatus of claim 4, wherein in the coupled page designation object, colors of the page designation objects are varied so as to enable each boundary the page designation objects to be recognized.

17. The document viewing apparatus of claim 1, wherein the display unit is a memory-type display device in which display contents displayed on the display unit are maintained after the document viewing apparatus is powered off.

18. A tangible computer-readable recording medium storing a program therein, wherein the program causes an information processing apparatus comprising a display unit and an operating unit, to function as a document viewing apparatus comprising:
the display unit to display a page designation object for receiving designation of a document or designation of any page in one document;
the operating unit to receive a page designating operation for the page designation object; and
a control unit;
wherein in case that there are a plurality of documents to be displayed, the control unit instructs the display unit to display the page designation objects corresponding to the plurality of documents to be displayed, respectively, and when the operating unit receives the page designating operation for any one of the page designation objects which are currently displayed, the control unit instructs the display unit to display a page designated by the page designating operation, the designated page being contained in a document corresponding to the page designation object for which the page designating operation is received.
